(19) United States
(12) Patent Application Publication
(10) Pub. No.: US 2024/0171627 A1
(43) Pub. Date: May 23, 2024

(54) SYSTEMS AND METHODS FOR COMMUNICATING BETWEEN A MOBILE DEVICE AND A SMART TELEVISION

(71) Applicant: VIZIO, INC., Irvine, CA (US)

(72) Inventor: Ravikumar Thangavel, Fremont, CA (US)

(73) Assignee: VIZIO, INC., Irvine, CA (US)

(21) Appl. No.: 18/511,883

(22) Filed: Nov. 16, 2023

Related U.S. Application Data
(60) Provisional application No. 63/426,332, filed on Nov. 17, 2022.

(51) Int. Cl. H04L 65/756; H04N 19/40

(52) U.S. Cl. CPC H04L 65/756; H04N 19/40

(57) ABSTRACT

Social media communications can be shared between disparate device types such as a mobile device and a television. A new social-media communication can be generated by identifying a user profile and media to be shared. A signed unform resource locator (URL) and unique identifier may be generated for the new social-media communication to enabling sharing the media with another device. The media may be uploaded and processed using the signed URL. For example, the media may be transcoded into a format based on the processing and/or display capabilities of a device associated with the user profile. The transcoded media may be stored in association with the signed URL. A notification corresponding to the social-media communication may be transmitted to the device associated with the user profile to enable access to the media.

### CROSS-REFERENCE TO RELATED APPLICATIONS

The present patent application claims the benefit of priority to U.S. Provisional Patent Application No. 63/426,332 filed Nov. 17, 2022, which is incorporated herein by reference in its entirety for all purposes.

### TECHNICAL FIELD

This disclosure relates generally to cross-platform data sharing technologies, and more specifically to cross-platform data sharing and logistics systems for the distribution and management of visual media on digital television systems.

### BACKGROUND

Computing devices can communicate with different devices using a verity of different protocols based on capabilities of the computing device and other device. For instance, computing device can communicate with other devices over the Internet, wireless communication frequencies such as Wi-Fi or Bluetooth, peripheral devices via a universal serial bus (USB) interface, etc. The complexity of communication and functionality available to the computing device may be based on the processing capabilities and/or software of the computing device. Devices that are not designed for general processing tasks, lack the capability for full functional communications with particular devices or networks. For example, a television may have processing components particularly configured for receiving, processing, and displaying video, but lack the functionality to exchange communications with particular network types such as networks frequently accessed by other devices for the presentation and exchange of media.

### SUMMARY

Methods are described herein for communicating across disparate device types. The methods may include receiving a request to transmit a communication to a media device, the request including an identification of media; generating an identifier associated with the media and a signed uniform resource locator; receiving via the signed uniform resource locator, the media, wherein the media is stored in associated with the signed uniform resource locator; transcoding the media based on characteristics of the media device; and transmitting the communication to the media device, wherein the communication includes the transcoded media.

Systems are described herein for presenting h communicating across disparate device types. The systems include one or more processors and a non-transitory computer-readable storage medium storing instructions that, when executing by the one or more processors, cause the one or more processors to perform any of the methods as previously described.

A non-transitory computer-readable medium described herein may store instructions which, when executed by one or more processors, cause the one or more processors to perform any of the methods as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following description is read with reference to the accompanying drawings.

FIG. 1 is a high-level block diagram of the disclosed system according to aspects of the present disclosure.

FIG. 2 is a functional-level block diagram of the disclosed system according to aspects of the present disclosure.

FIG. 3 is a state diagram of an example upload and process content steps according to aspects of the present disclosure.

FIG. 4 is a state diagram of an example process of getting messages and media from a smart TV according to aspects of the present disclosure.

FIG. 5A-5B is a state diagram of an example process for managing Friend Requests according to aspects of the present disclosure.

FIG. 6 is a state diagram of example process for managing Friend Status and Updates according to aspects of the present disclosure.

FIG. 7 is a system state flow diagram of an example process of posting a message (gram) according to aspects of the present disclosure.

FIG. 8 illustrates three example user interfaces presented by a media sharing application of a mobile device according to aspects of the present disclosure.

FIG. 9 illustrates two example user interfaces presented by a media sharing application of a media device according to aspects of the present disclosure.

FIG. 10 illustrate a flowchart of an example process for transmitting data between a mobile device and a display device according to aspects of the present disclosure.

FIG. 11 illustrates an example computing device according to aspects of the present disclosure.

### DETAILED DESCRIPTION

Methods and systems are described herein for a media sharing system configured to share media between disparate device types in optimized media format. Some device types may be configured for presenting particular types of media such as television, which is configured for video. The devices may not be configured to present other types of media or may present other types of media in a lower quality. Televisions may process non-video media (e.g., text, images, audio, etc.) in a separate processing pipeline from video media, which may cause the non-video media to be presented in a sub-optimal form and/or format (e.g., low resolution, undesirable aspect ratio, undesirable size, etc.). For example, images are often processed at a lower resolution regardless of the original resolution in which the image was captured causing poor display quality. The media sharing system described herein may transcodes media for presentation on disparate device types according to the processing capabilities of a respective device to enable native presentation of non-native media. For instance, the media sharing system may wrap still images in an MP4 or other compatible video container represented by a single I-Frame for presentation by a display device. The display device may then display the image as a video having a single frame. The image can be presented by the display device until it is replaced by other content.

The media sharing system enables high-quality video and image sharing between connected ‘friend’ accounts to be displayed on a television or home theater display (hereinafter, collectively referred to as a “television” or “TV”). Media can be uploaded from a user's mobile device and a notification may be sent to a contact of the user.

The media sharing system is configured to connect users through sending videos or photos from a mobile device to contact's television. The video or photos may be presented using the high-quality video display of the television. The video or photos may be presented using High-Dynamic Range (HDR) or Ultra-High Definition (UHD) video or still images.

In some instances, the media sharing system may be facilitated by a mobile application (e.g., executing on a mobile device such as a smartphone, tablet, etc.), a display device application executing on a display device, and one or more servers (e.g., a cloud service, etc.). Communications including content (e.g., video, audio, text, and/or the like) can be exchanged between the mobile application and the display device application using the one or more servers. The one or more servers may provide transcoding and/or security services to the mobile application and the display device application. For example, a mobile device (e.g., a smartphone, tablet, etc.) may transmit a communication to a server that includes a user identifier (e.g., usable to identify a receiving device such as a device executing a mobile device application or display device application, etc.) and a payload (e.g., content to be presented by the device executing the mobile device application or display device application, etc.). The one or more servers may transcode the communication into a native form or format of the receiving device (e.g., depending on the processing capabilities of the receiving device, etc.) to enable the communication to be displayed in a particular form or format. The one or more servers may store the transcoded communication in memory and transmit a notification to the receiving device indicating the presence of the transcoded communication. Upon receiving a request for the transcoded communication, the one or more servers may transmit the transcoded communication to the receiving device for presentation.

The media sharing application may generate and store user account information. A user account may be associated with user information (e.g., a name of the user or a username of the user, user interests, demographic information, device information, etc.), a user identifier, account identifier, an identification of contacts of the user (e.g., friends, family, colleagues, etc.), historical communications generated by the user and/or addressed to the user, an identification of one or more devices associated with the user, information associated with the one or more devices (e.g., device type, processing capabilities, etc.), combination thereof, or the like. In some instances, the user account may also be generated and/or stored memory of a device executing a display device application and/or the mobile application.

A user may generate a new communication for one or more contacts of the user by selecting content to share, providing text to present along with the selected content, providing an identification of the one or more contacts (e.g., a name, username, user identifier, account identifier, etc.). For example, a user may take a picture and select a contact to share the picture with. The user may also provide a message to be displayed with the picture. The media sharing system may use the identification of the one or more contacts to identify a user account associated with each of the one or more contacts. The media sharing system may transmit a notification to the receiving device (e.g., via the mobile application or the display device application executing on the receiving device). In some instances, the notification may be generated when a new communication is received at the mobile device or display device. In other instances, the mobile device and/or display device may receive a notification of the new communication and request access to the new communication in response to receiving the notification. The notification may be presented over a portion of a display of the mobile device or display device. The user may select the new the new communication for display causing the new communication to be presented by the display of the mobile device and/or display device. The new communication may be presented in a portion of the display of the mobile device and/or display device or using approximately the entire display (e.g., “full screen”, etc.).

The content may be processed by the media sharing system to enable presentation of the content in particular form or format based on a device type of the receiving device and/or the processing capabilities of the receiving device. Processing the content may include translating the content into a different format (e.g., different file type, container, etc.), altering the form or format of the content (e.g., such an aspect ratio, size, resolution, frame rate, color correction, upscaling. etc.), combinations thereof, or the like. The media sharing system may process the content based on processing information stored in the user account associated with the receiving device. The processing information may include, but is not, limited to a device type associated with the receiving device, processing capabilities of the receiving device, hardware and/or software installed on the receiving device, user preferences, combinations thereof, or the like. For example, if the receiving device is a television (or a device that may not be configured to present single images), the media sharing system may wrap the content into a video-based container causing the picture to be presented as a single frame of video rather than as an image enabling the television to present the content in a higher quality.

The media sharing system may secure the presentation of the content by the receiving device using encryption, time limits, combinations thereof, or the like. For example, the media sharing system may secure the content causing the receiving device to provide access credentials such as a username and/or password, pin, voice key, combinations thereof, or the like to present the media. In another example, the shared content can be time or display sensitive such that the shared content may be deleted upon being displayed for a predetermined time interval. Alternatively, or additionally the shared content can be deleted after a predetermined time interval regardless of whether the shared content was displayed. In some instances, the media sharing system may secure the shared content using both access credentials and time limits. Users may moderate the shared content (adding and removing content), moderate content viewable from other users, restrict content by age, prevent the display of flagged content, report inappropriate content, and/or the like.

In an illustrative example, a computing device may receive a request from a sending device to transmit a communication to a receiving device. The request may include an identification of media to be presented by the receiving device. The computing device may be a component of a service that enables communications between disparate device types. For example, the computing device may operate within a cloud network. The computing device may operate between a sending device (e.g., another computing device, mobile device, media device, any other processing device that is capable of communicating over a network, etc.) and a receiving device (e.g., another computing device, mobile device, media device, any other processing device that is capable of communicating over a network, etc.). The computing device may be configured to process communications transmitted to and from the sending device and the receiving device to enable the receiving device to present communications (and content included therein) efficiently and in a high-quality form and/or format. For example, the sending device may be a mobile device and the receiving device may be a media device. The computing device may receive a communication request from the mobile device to share content (e.g., images, video, audio segments, text, etc.) with the media device.

In some instances, the sending device may be authenticated before transmitting the request to the computing device. For example, the sending device may transmit an identification of a user account of the media sharing application executing on the sending device and access credentials that authenticate the identity of a user of the sending device. In some instances, the sending device may request a token (e.g., a JWT token, an object, etc.) from an authentication service. The sending device and/or the user thereof may be authenticated by the authentication service using for example, access credentials, cryptographic keys, digital signature, tokens, personal identifiable information, and/or the like. Once authenticated, the authentication service may transmit a token (e.g., also referred to as a sending token) associate with the sending device and/or the user thereof. The sending device may provide the token to the computing device to identify the sending device as an authenticated device. In some instances, the token may expire to cause the sending device to repeat the authentication process with the authentication service.

The sending device may transmit the token with the request to transmit the communication to indicate that the sending device and/or the request is authenticated. The computing device may then use information in the request to identify the receiving device. The receiving device may be a device associated with a same user (e.g., such as a media device operated by a same user as the user operating the sending device) or the receiving device may be associated with a different user that is a contact of the user operating the sending device. The computing device may identify a user account associated with the request using a name of the receiving user, a user identifier corresponding to the receiving user, an identifier of a user account, a device identifier, a device address (e.g., an IP address, a MAC address, etc.), and/or the like. The computing device may perform a user account search to identify a receiving device associated with the user account.

The computing device may then determine characteristics from device information associated with the computing device. The device information may include an identification of the receiving device, an address of the device (e.g., an IP address, MAC address, a URL, a memory address, or the like), a device type (such as, but not limited to, a smartphone, tablet, computing device, server, television, monitor, etc.), processing capabilities (e.g., processing cores, processing speed, amount of volatile and/or volatile memory, presence of a graphics processing unit (GPU), an identification of a quantity GPU cores, graphical processing unit memory or video memory, an identification of a maximum resolution of a display, refresh rate of the display, a response time of the display, etc.), an identification of connected peripherals (e.g., such as a camera, microphone, keyboard, etc.), an identification software installed on the device (e.g., such as a media-sharing application, operating system, etc.), user preferences (e.g., presentation preferences, etc.), combinations thereof, or the like.

The computing device may generate an identifier associated with the media and a signed uniform resource locator (URL). The computing device may generate one or more identifiers associated with the communication to enable tracing the communication and authenticating access to the communication. In some instances, the computing device may generate a first identifier that corresponds to the communication and a second identifier that corresponds to the content to be included in the communication. If the content includes two or more media instances, then an identifier may be generated for each instance of media.

The signed URL may be usable by the sending device to upload the content to be included in the communication. Alternatively, the computing device may transmit an identification of aa network address, memory address, etc. to the sending device to enable the sending device to upload the content.

The computing device may receive, via the signed uniform resource locator, the content. The content may be stored in association with the signed uniform resource locator. For instance, the content may be stored in a memory space defined based on the signed uniform resource locator. Alternatively, or additionally, the content may be stored in association with the communication identifier (e.g., the first identifier) and/or the one or more second identifiers associated with the content. For example, the first identifier and/or the one or more second identifiers may be translated into a memory address usable to store the content.

The computing device may transcode the content based on characteristics of the receiving device. The computing device may include one or more transcoders with each transcoder being configured to transcode different input content and/or generate different output content. For example, a first transcoder may be configured to transcode an image file into video by wrapping the image into a video-based container and setting a flag in the image file header to cause the image file to recognized as an I-Frame. The image file may be presented as an adaptive bitrate stream comprising a single frame of video. The first transcoder or a second transcoder may be configured to modify the single frame of video to enable the presentation of the single frame of video to take advantage of the processing capabilities of the receiving device. For instance, the first transcoder or the transcoder may increase a resolution of the single frame of video, adjust an aspect ratio, adjust a frame rate (for content comprising more than one frame of video), perform color correction or other image processes (e.g., increase or decrease sharpness, change a depth of field, etc.), etc. The computing device may select the transcoder to transcode the content based on the receiving device, the content, and/or user preferences.

The computing device may define one or more fields in the transcode image file to further define the presentation of the content. For example, the computing device may define access restrictions that may require the receiving device to enter in access credentials to present the transcoded content (e.g., a pin, username and password, voice key, cryptographic key, etc.) and/or define a expiration of the content. For example, the computing device may define the expiration so that the content is deleted (or prevented from presentation) after a predetermined time interval. The predetermined time interval may be configured to start when the content is received at the receiving device or when the content is first presented by the receiving device. The one or more fields may also define presentation characteristics such as, but not limited to, a presentation size, a presentation layout, a thumbnail of the content, a presentation location of the transcoded content or the thumbnail, etc.)

The computing device may transmit the communication to the receiving device. In some instances, the communication can be transmitted by transmitting the signed URL to the receiving device enabling the receiving device to download the communication using the URL. In other instances, the communication may be transmitted over web-based communication protocol or other network protocol. The communication may include the transcoded content and an identification of the user account associated with the sending device and/or the user thereof. The transcoded content may be presented by the receiving device according to the presentation characteristics.

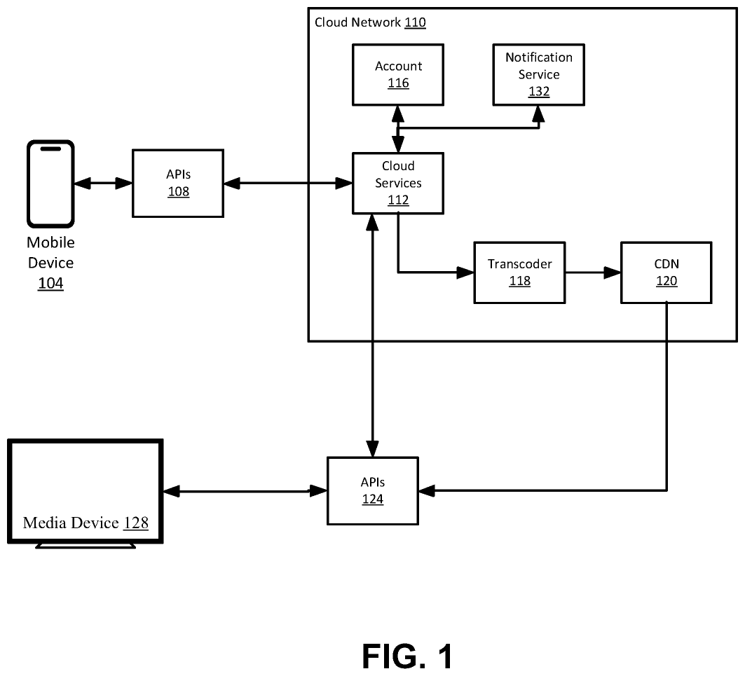

FIG. 1 is a high-level block diagram of the disclosed system according to aspects of the present disclosure. Mobile device 104 may share content (e.g., audio, video, images, text, combinations thereof, or the like) with disparate device types such as other mobile devices, televisions, computers, etc. Mobile device 104 may generate a new communication via a media-sharing application executing on mobile device 104. Communication may include content and an identification of a user or user account with whom the communication is to be shared. Mobile device 104 may transmit the communication (via the media-sharing application) to cloud network 110 using application programming interfaces (APIs 108). APIs 108 may be accessed from within mobile device 104 (e.g., via a media-sharing application, etc.), accessed by mobile device 104 through a remote server (positioned between mobile device 104 and cloud network 110 as shown), and/or accessed within cloud network 110. APIs 108 may enable direct access to functions of cloud network 110. In some instances, APIs 108 may enable translation of the communication into a form or format that can be processed by cloud network 110.

In some instances, mobile device 104 may transmit the communication to cloud network through a signed URL. Mobile device 104 may request a signed URL for a new communication from cloud network 110 and, in response, cloud network 110 may transmit the signed URL to mobile device 104. Mobile device may transmit the communication using the signed URL.

Cloud network 110 may include one or more distributed devices configured to provide network services, transcoding, communication routing, load balancing, etc. Cloud network 110 may include cloud services 112 that manages the operations of cloud network 110 and the routing of communications between devices. Cloud services 112 may access account 116 to identify a user account associated with the user that is to receive the communication. Cloud services 112 may identify device information associated with the user account. The device information may include information associated with a device capable of presenting the communication to a user of the user account. The device information may include an identification of a device (e.g., such as media device 128, another mobile device, a computing device, etc.), an address of the device (e.g., an Internet Protocol (IP) address, MAC address, a URL, a memory address, or the like), a device type (such as, but not limited to, a smartphone, tablet, computing device, server, television, monitor, etc.), processing capabilities (e.g., processing cores, processing speed, amount of volatile and/or volatile memory, presence of a graphics processing unit (GPU), an identification of a quantity GPU cores, graphical processing unit memory or video memory, an identification of a maximum resolution of a display, refresh rate of the display, a response time of the display, etc.), an identification of connected peripherals (e.g., such as a camera, microphone, keyboard, etc.), an identification software installed on the device (e.g., such as a media-sharing application, operating system, etc.), user preferences (e.g., presentation preferences, etc.), combinations thereof, or the like.

Cloud services 112 may pass the content from the communication and the device information to transcoder 118. Transcoder 118 may transcode the content into a higher quality version of the content based on the device type, processing capabilities of the device, and/or user preferences. For example, the content may include an image addressed to media device 128. Media device 128 (e.g., a television) may not be configured to efficiently render images or render images in as high quality as video. Transcoder 118 may transcode the image by converting the image into a highest resolution presentable by media device 128 that preserves the quality of the image and wrapping the image into video-based container (e.g., MP4, etc.). By wrapping the image into the video-based container, media device 128 can render the image as a single frame of video. Media device 128 renders the image as if the image is video (e.g., as a single video frame) enabling media device 128 to process the image more efficiently (e.g., using a video processing pipeline, etc.) and in a higher quality than if media device 128 rendered the image as an image. Transcoder 118 may pass the transcoded content for storage by content delivery network (CDN 120) for distribution to the device. CDN 120 may store the transcoded content until a request for the transcoded content is received.

Alternatively, cloud services 112 may not transcode the content until the device associated with the user account addressed by the communication requests the content. For example, upon receiving a notification of a content associated with a user account, media device 128 may request the content. The request may include an access token (e.g., such as a JavaScript Object Notation (JSON) Web Token (JWT), an object, etc.), access credentials (e.g., a username and password, a pin, voice key, etc.), an identification of the device, device information, user preferences, etc. Cloud services 112 may use the information included in the request to determine a transcoding scheme to tailor presentation of the content to the media device (e.g., minimum or maximum resolution, a frame rate, an aspect ratio, color correction, etc.).

Cloud services 112 may register the communication in association with the user account with notification services 132. In some instances, cloud services 112 may register the communication in association with the user account in parallel with transcoding the content of the communication at 116. In other instances, cloud services 112 may register the communication in association with the user account before passing the content of the communication to transcoder 118. In other instances, cloud services 112 may register the communication in association with the user account once the transcoded content is passed to CDN 120. Notification services 132 may transmit notifications to devices associated with the user account when a communication is registered with notification services 132. For example, a device may transmit a request (via a media-sharing application) to cloud services 112 for outstanding notifications. The request may include an identification of the device, the instance of the media-sharing application), and/or an identification the user account. The device may transmit the request for notifications in regular intervals, upon receiving user input, upon detecting event (e.g., upon being powered on, executing the media-sharing application, etc.), combinations thereof, or the like. Cloud services 112 may receive the request, identify the user account using the request, retrieve the outstanding notifications (e.g., notification that have not yet been transmitted to the user of the user account, have not been presented to the user of the user account, etc.) from notification services 132, and transmit the outstanding notifications to the device. Alternatively, or additionally, cloud services 112 may transmit outstanding notifications to each device associated with the user account (via the media-sharing application executing on that device) as a push notification, a communication (e.g., such as a text, email, direct communication, instant message, etc.), or the like via other APIs 124. The notifications may be popup communications that display, usually at bottom of a screen, to alert the user for new events on the media sharing application or media device.

Media device 128 may receive a notification of the new communication via notification services 132 of cloud network 110. The notification may include an access token usable by media device 128 access the transcoded content that corresponds to the communication identified by the notification. Alternatively, or additionally, media device 128 may request a token from CDN 120 or cloud network 110. Media device 128 may transmit a request for the transcoded content where the request can include the token. In some instances, the request may be transmitted using a signed URL. Cloud network 110 may verify the access token (e.g., checksum, comparing the access token another access token, etc.). If the access token can be verified, then CDN 120 may transmit the transcoded content to media device 128 (e.g., using other APIs 124).

Media device 128 may communicate with cloud network 110 through other APIs 124. Other APIs 124 may include one or more application programming interfaces configured to enable access to services of cloud network 110. Other APIs 124 may be the same as APIs 108 or different (e.g., configured for different device types). For example, APIs 108 may be configured to enable mobile device 104 (and/or computing device, server, etc.) to communicate with cloud network 110 such as executing functions of cloud network 110, etc. and other APIs 124 may be configured to enable media device 128 (e.g., display device, television, etc.) to communicate with cloud network 110. Like APIs 108, APIs 124 may be accessed from within media device 128 (e.g., via a media-sharing application, etc.), accessed by media device 128 through a remote server (positioned between media device 128 and cloud network 110 as shown), and/or accessed within cloud network 110.

Once the media device 128 receives the transcoded content, media device may begin presenting the transcoded content. In some instances, the transcoded content may be secured using access credentials such as, but not limited to, a username and password, pin, voice key, combinations or the like. In those instances, media device 128 may request access credentials before presenting the content. In some instances, media device 128 may limit the presentation of the transcoded content to a particular device, to a particular time interval (e.g., as a time interval after receiving the notification, a time interval after presenting the transcoded content, or the like), combinations thereof, or the like.

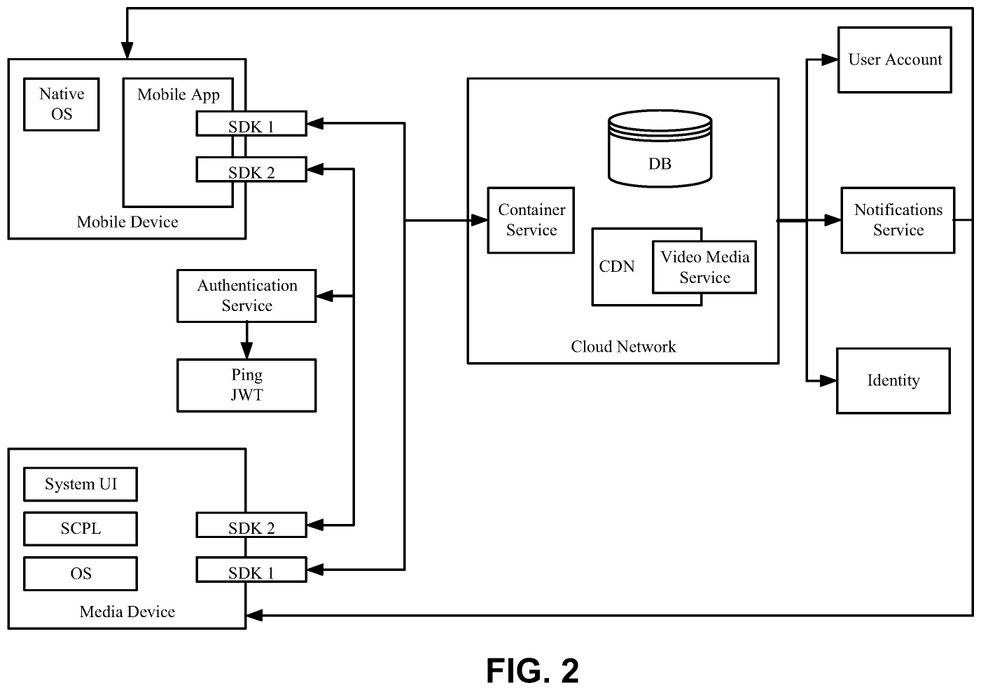

FIG. 2 is a functional-level block diagram of a media sharing system according to aspects of the present disclosure. A mobile device may include an operating system that manages particular operations of the mobile device such as phone functions, contacts, messaging, camera, memory, etc. The mobile device may execute a mobile app (e.g., a media sharing application) to enable communicating content with disparate devices. The mobile app may include one or more standard development kits (e.g., SDKs) that include executable instructions accessible to the mobile app and enable the mobile app to execution functions of media sharing application. For example, a first SDK may access services of a cloud network via a container service of the cloud network. The container service manages access to containers (e.g., discrete environments, etc.) of the cloud network. Container service may also manage the instantiation, updating, and termination of containers for workload management, load balancing, etc.

The cloud network may include the container service, one or more databases, a video media service (e.g., a transcoder), a CDN, and/or the like. The cloud network may access additional services that may be internal to the cloud network and/or provided by one or more remote servers. The additional services include a user account service (e.g., stores data associated user accounts, etc.), a notifications service (e.g., notification services 132), an identity service (e.g., configured to identify users, user accounts, content, transcoders, etc.).

The mobile device may transmit media to a television for presentation, the television may include an operating system, one or more operating libraries, user interfaces, and/or the like that enable the functions of television. The television may also include one or more SDKs that enable the television to access the cloud network, receive from the mobile device, transmit communications, secure communications, etc.

In some instances, a proxy service may be established to secure some of the operations. SDKs may be used to access services of the proxy service. For example, an SDK may be used to ping the proxy service to generate tokens (e.g., such as when a new communication is generated or received), verify tokens to authenticate requests, etc.

For example, the mobile app of the mobile device may request a signed URL to access cloud processes that can accept content to be shared. The mobile app can transmit a gram (e.g., a communication including text and/or one or more images, videos, audio segments, etc.) utilizing a cloud upload service. Upon completing the uploading process, the cloud upload service may then initiate a transcoding service to convert the content of the gram into a compatible media format for presentation by the television. The transcoding service for shared video content can format or create an adaptive bitrate stream that is a predetermined quality (e.g., best quality for the television, preferred quality based on user input, etc.) for display on the destination television.

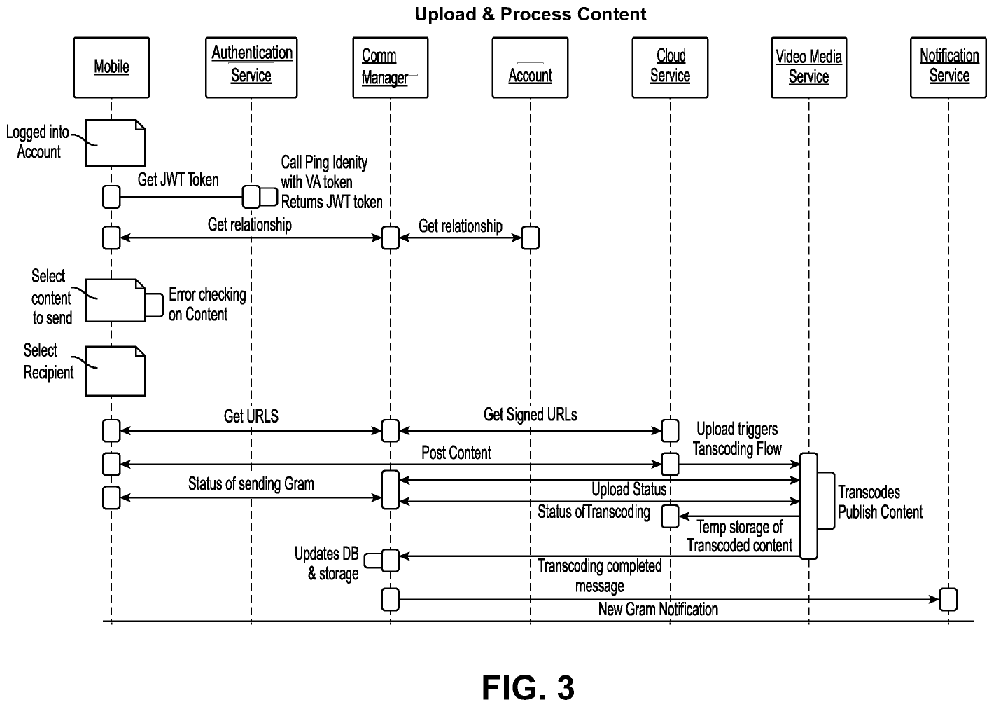

FIG. 3 is a state diagram of an example upload and process content process according to aspects of the present disclosure. Some media devices may process some media differently, which may cause some media to be presented at a lower quality than other media. For example, some smart televisions when capable of displaying 4K or UHD video are restricted to showing only 1080p still images when images are processed by the television using the still image pathways (API). The example upload and process content process of FIG. 3 may cause still images to be processed as video by passing the still image through a video transcoding process and encoding the still image in a video program stream protocol (e.g., such as a MP4 file, etc.). The image file may be identified as an I-frame by setting certain data flags in the file header prior to sending the image from the network to the television. When modified image file is received at the television, the image file is processed as video media, even though the still image is just a single frame. The television can render the image file as video media in a highest resolution available to the television in the same manner as video media. The example upload and process content process is illustrated in the sequence diagram of FIG. 3.

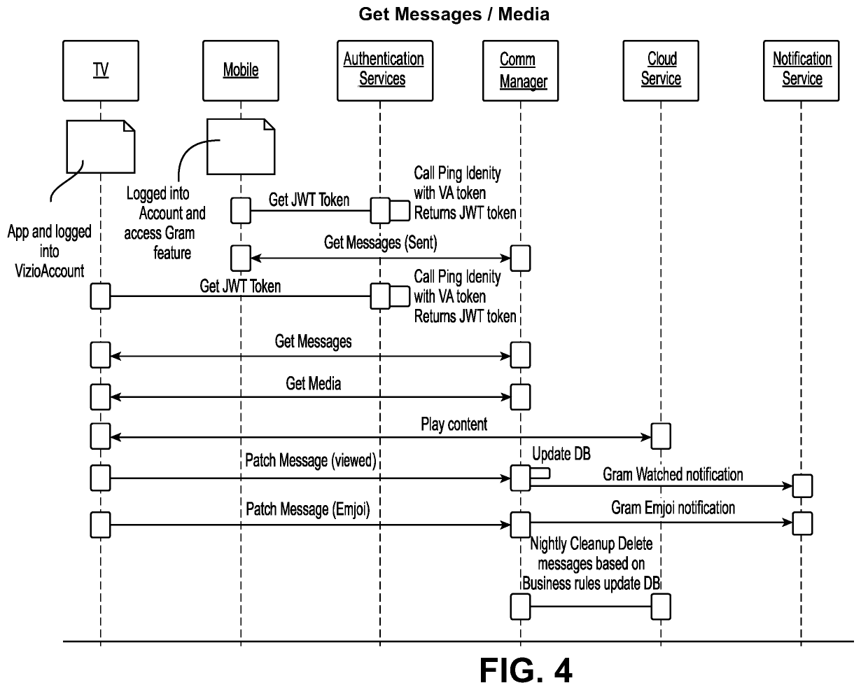

FIG. 4 is a state diagram of an example process of getting messages and media according to aspects of the present disclosure. A media sharing application can transmit and receive media from other mobile devices, computing devices, media devices (e.g., televisions, etc.). In some instances, the media sharing application may enable presentation of media received by the mobile device at another device (e.g., such as another mobile device, computing device, media device, etc.). For example, the media sharing application may receive information associated with communications and present that content on a display device. The get and play process shown in FIG. 4 illustrates the operations of the media sharing system in which the media sharing application executes a call to get a list of grams that the media sharing application operating on the mobile device has transmitted or received. An identification of the grams may be received including the content of the communications and/or thumbnails of the content (compressed in size images). The media sharing application operating on the media device may receive information associated with the grans and present the content. The example process of getting messages and media is illustrated in the sequence diagram of FIG. 4.

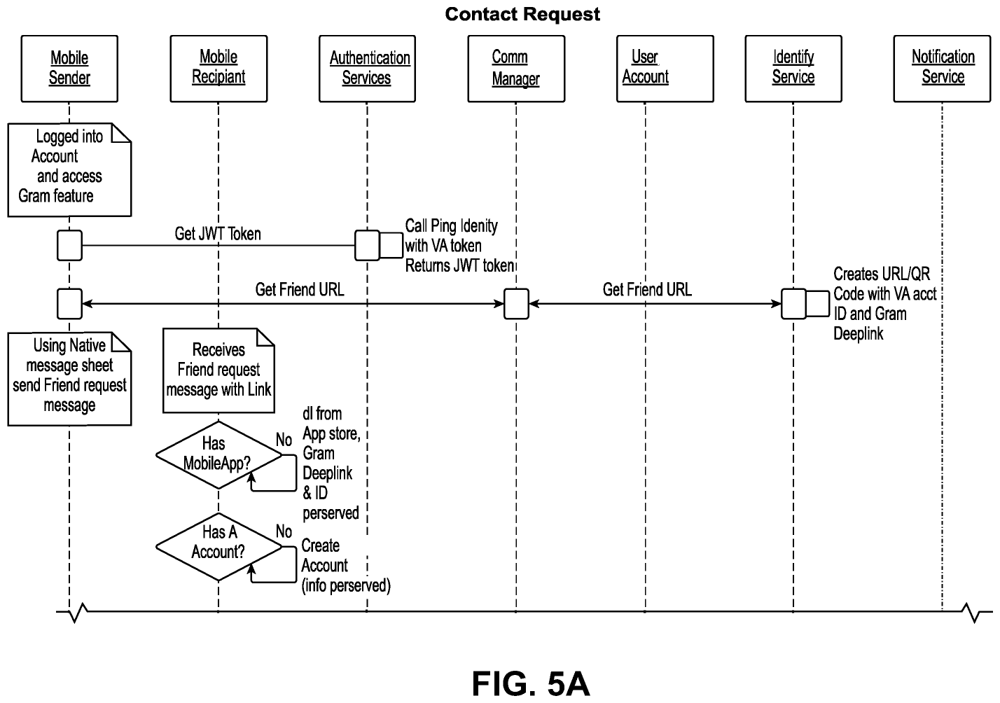

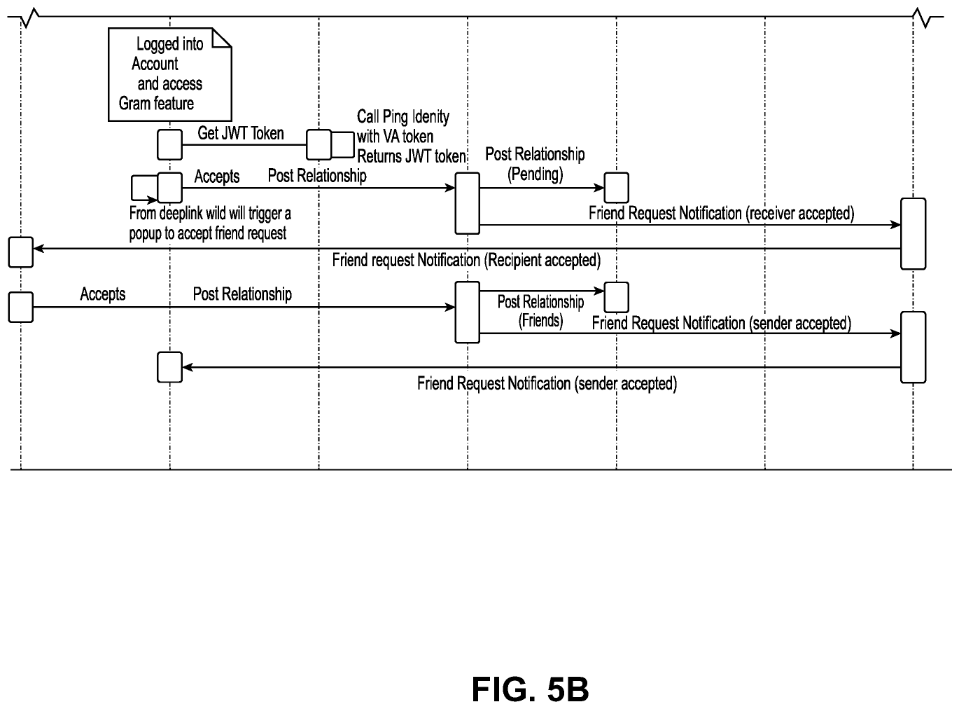

FIG. 5A-5B is a state diagram of an example process for managing Contact Requests according to aspects of the present disclosure. The media sharing application may manage contacts associated with a user of the media sharing application. The contacts may be friends, colleagues, family, users, etc. associated with the user. The process may be initiated from a media sharing application executing on a mobile device of a first user (e.g., mobile sender) that requests to add a second user (mobile recipient) as a contact of the first user. The media sharing application may communicate with a comm manager that executes within a remote device (e.g., server, cloud service such as cloud service 112, etc.) to provide information of the media sharing system to the media sharing application such as, but not limited to, user information, user accounts, user statuses, etc. The process may include generating a link (e.g., URL, quick response (QR) code, etc.) that may be transmitted to the mobile recipient. If the mobile recipient does not have a media sharing application and/or an account, then executing the link may enable the mobile recipient to download the media sharing application and/or create an account. The mobile recipient may then accept or cancel the contact request. If the contact request is accepted, a notification may be transmitted to the mobile sender indicating that the mobile recipient accepted the contact request. In some instances, the mobile sender may then confirm the contact request causing a notification to be transmitted to the mobile recipient.

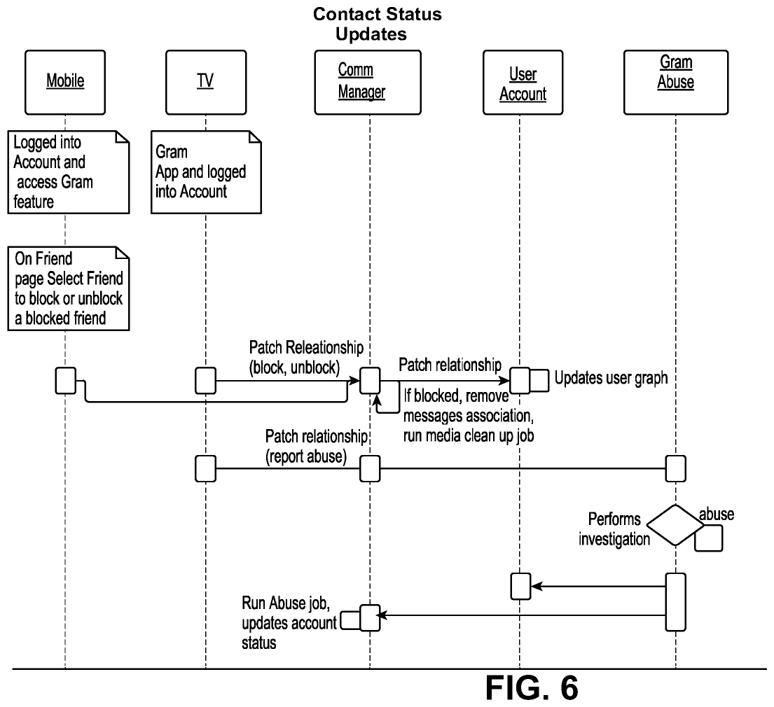

FIG. 6 is a state diagram of example process for managing contacts Status and Updates according to aspects of the present disclosure. The example process for managing contact Status and Updates may be executed by a media sharing application to retrieve information associated with a contact. The media sharing application may transmit requests to a comm manager manage contacts of a user such as adding a contact, removing a contact, blocking a contact, etc. For example, a first user may transmit a status request to comm manager with an identification of a second user or a second user account. Comm manager may return a blocked or unblocked response indicating that the second user is blocked or not blocked for the first user. If blocked, the first user may be prevented from transmitting communications to the second user and the second user may be prevented from transmitting communications to the first user. Comm manager may determine that a communication is associated with a blocked user and discard the communication to prevent further processing of the communication. The first user may transmit a block request to block the second user or an unblock request to unblock the second user. The comm manager may store an indication of a status of the second user (as blocked or unblocked) in the user account associated with the first user. An abuse service may operate to determine of the block/unblock system is being abused (e.g., too many requests, repeated requests, etc.), which may impact system or user performance, etc.

In some instances, a media device can generate guest accounts using a third-party user authentication service. Guest accounts may be un-credentialed accounts that do not use a sign-in process. A token (e.g., such as a JWT, etc.) may be requested from the authentication service. When a refresh token is called, a new token may be generated which authorizes the guest account. The guest account may not be linked to the mobile guest account, or to a credentialed account. Guest account may receive communications from other user accounts. In some instances, guest accounts may be temporary and expire after a time interval.

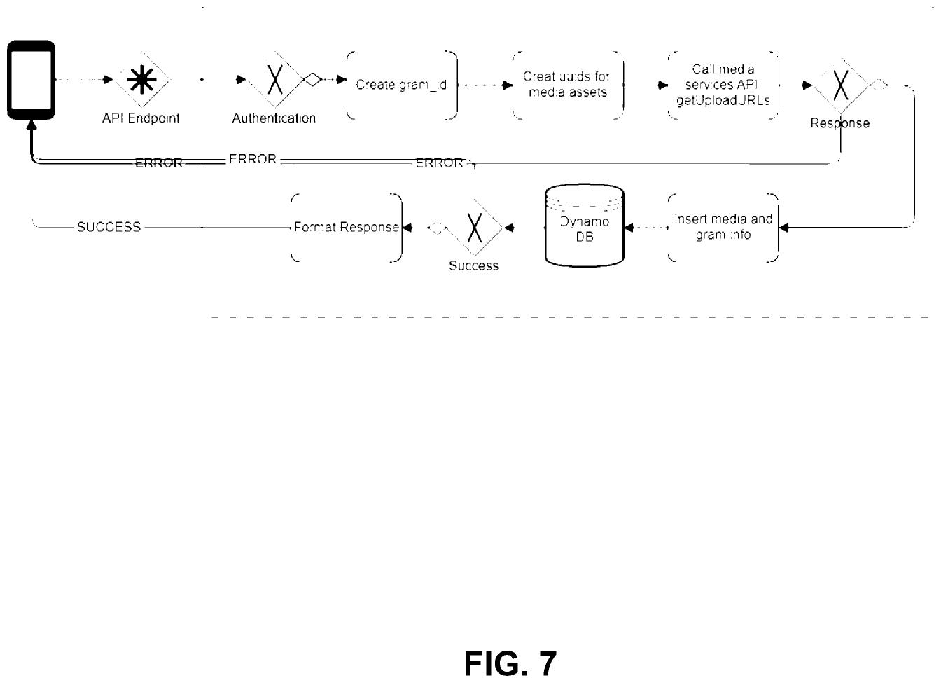

FIG. 7 is a system state flow diagram of an example process of posting a communication (gram) according to aspects of the present disclosure. A communication can be posted (e.g., transmitted) to another user or device of a media sharing system. A media sharing application of a mobile device may transmit a call through API endpoint to the media sharing system. The request may be authenticated (e.g., using a token, access credentials, or the like). If the authentication fails an error message may returned to the media sharing application. If the authentication passes, the media sharing application may generate a communication identifier and a content identifier of any content to be transmitted with the communication. The media sharing system may execute a call to media services API to generate a signed upload URL (e.g., getUploadURLs). If the media services API does not return a response (e.g., or returns a null, undefined, etc. response), the media services API may return an error to media sharing application of a mobile device.

If the media services API returns a URL the process continues where the content and communication identifier are inserted into a new communication. In some instances, the content may be transcoded before being inserted (e.g., into a different form or format, file type, etc.). The new communication may be stored in a database of communications. The database may be used to populate the media sharing application of a mobile device with communications transmitted from and/or received by from media sharing application. Old communications and communications removed by the media sharing application may be removed from the database to prevent the communications from being repopulated within the media sharing application. If the communication is not stored successfully, an error may be returned to the media sharing application of a mobile device. If the communication is stored successfully, the process continues where a response may be formatted for presentation by the media sharing application of a mobile device. The response may be formatted based on default rules, user preferences, the mobile device, the communications, the content, and/or the like. For instance, the response may include a thumbnail of the content.

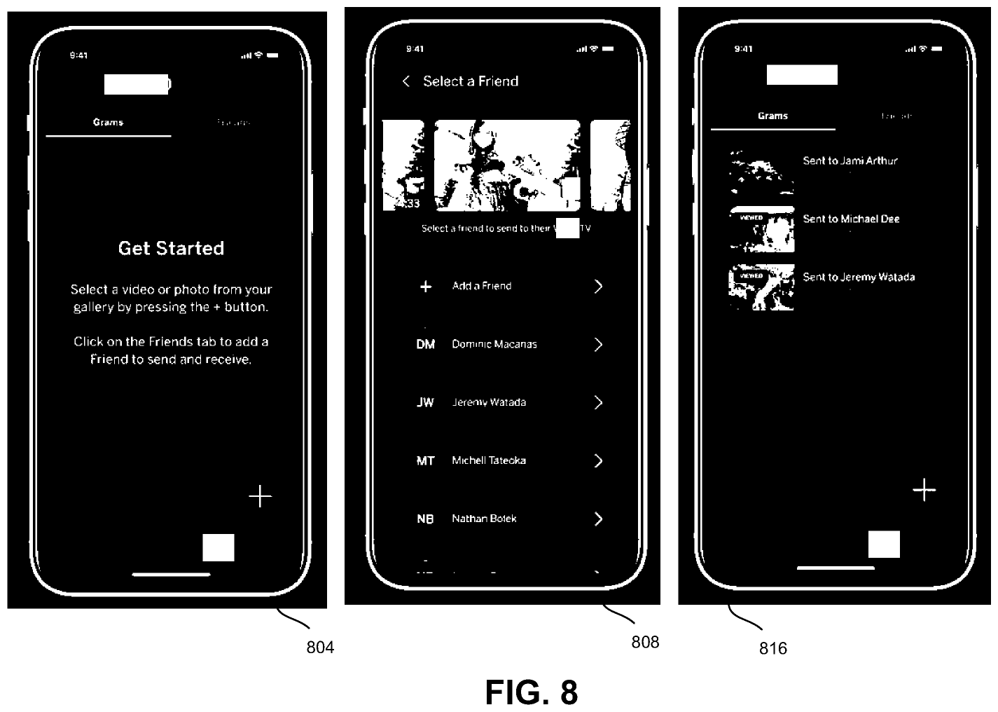

FIG. 8 illustrates three example user interfaces presented by a media sharing application of a mobile device according to aspects of the present disclosure. User interface 804 depicts a start screen that provides information to begin operating a media sharing application. User interface 804 includes one or more tabs such as grams (e.g., communications), and friends (e.g., a list of contacts). User interface 804 may include a button that can be selected to begin generating a new gram. Upon selecting the button, user interface 808 may be presented providing a presentation of content for selection (e.g., such videos, photos, audio segments, etc.) and a list of users that are to receive the gram. Upon selection of content and one or more users, user interface 816 may be presented. User interface 816 includes depicts the grams that have been transmitted. The grams that are depicted may be deleted after a predetermined time interval. User interface 816 may also include the button to begin generating a new gram.

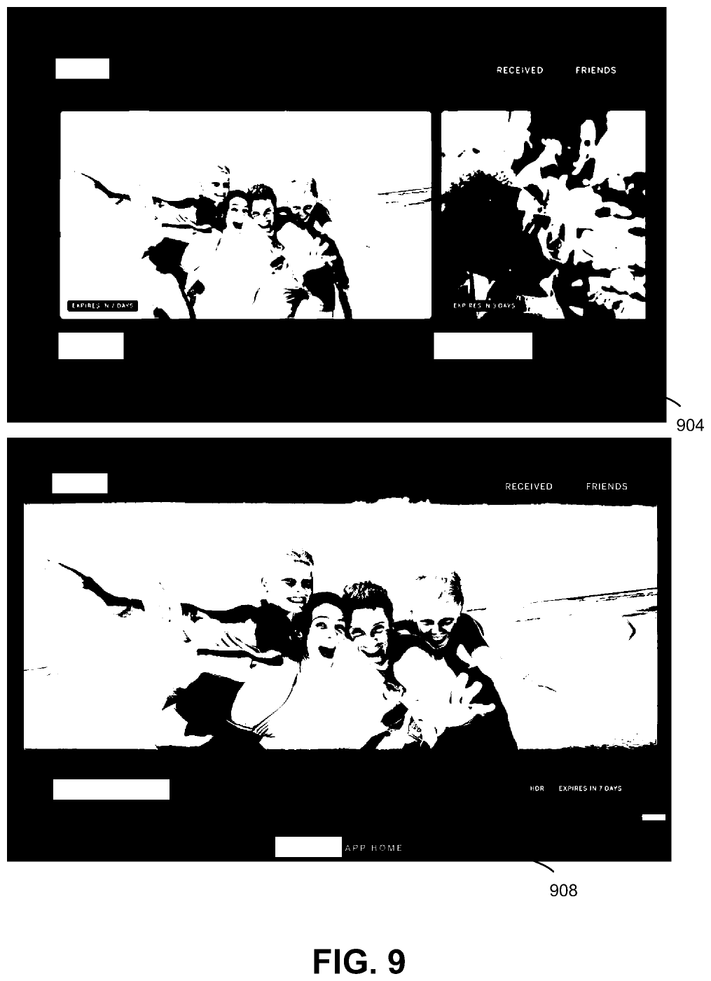

FIG. 9 illustrates two example user interfaces presented by a media sharing application of a media device according to aspects of the present disclosure. A media device may execute a media sharing application to present content received from remote devices. The media sharing application of the media device may be configured to present content in a form or format based on a device type of the media device, processing capabilities of the media device, and/or user preferences. The grams received by media sharing application of the media device may be configured to be presented in a highest quality capable of presentation by the media device (e.g., a highest resolution, frame rate, etc.).

The content of grams may be presented in any format. For example, content can be presented in a side-by-side view (user interface 904) or in a full screen view (user interface 908). In some instances, grams or the content there of may be presented in a thumbnail form in which the thumbnail form of one or more grams may be presented within a same user interface. The user interfaces of media sharing application of the media device may include an icon that may be selected to present grams that have been received and icon that can be selected to manage contacts (e.g., view contacts, search for contacts, add contacts, remove contacts, block or unblock contacts, etc.). While presenting content of a gram, the user interface may present properties of the gram such as a geolocation associated with the content, an identification of a user or user account that transmitted the gram, an expiration time interval of the gram (before the gram will be removed from the media device), etc.

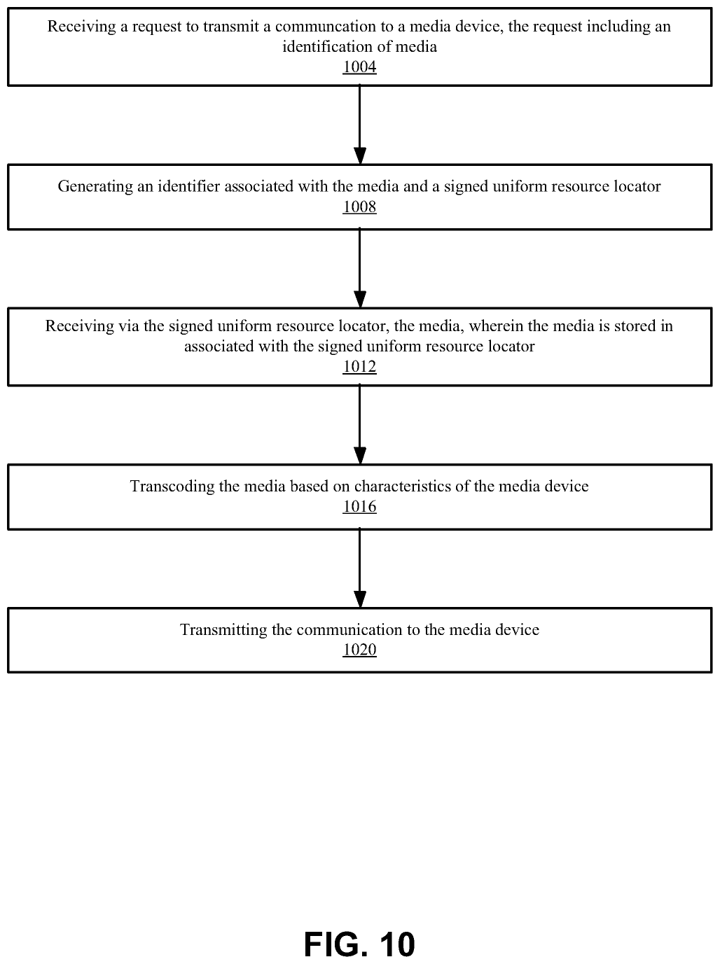

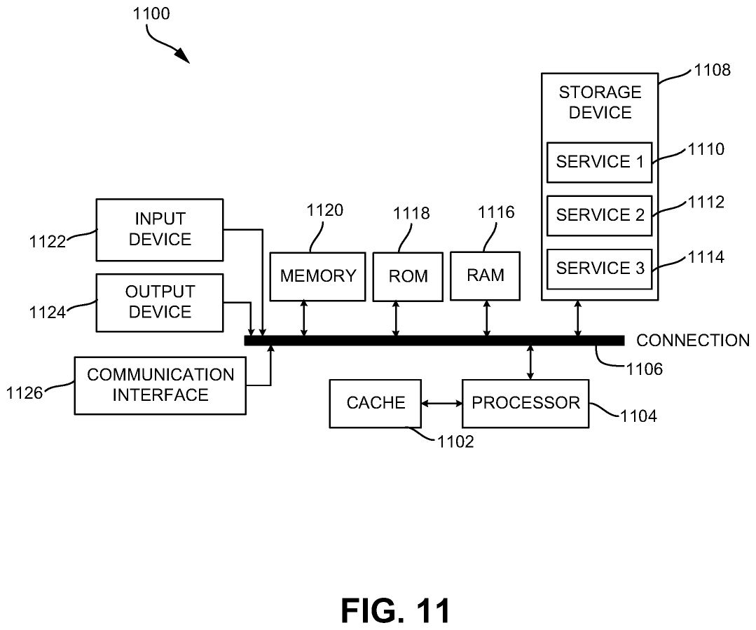

FIG. 10 illustrate a flowchart of an example process for transmitting data between a mobile device and a display device according to aspects of the present disclosure. At block 1004, a computing device may receive a request to transmit a communication to a media device. The request may include an identification of media. The computing device may be a component of a service that enables communications between disparate device types. For example, the computing device may operate within a cloud network (e.g., such as cloud network 110 of FIG. 1, etc.). The computing device may operate between a sending device (e.g., another computing device, mobile device, media device, any other processing device that is capable of communicating over a network, etc.) and a receiving device (e.g., another computing device, mobile device, media device, any other processing device that is capable of communicating over a network, etc.). The computing device may be configured to process communications transmitted to and from the sending device and the receiving device to enable the receiving device to present communications (and content included therein) efficiently and in a high-quality form and/or format. For example, the sending device may be a mobile device (e.g., such as mobile device 104 of FIG. 1) and the receiving device may be a media device (e.g., such as media device 128 of FIG. 1). The computing device may receive a communication request from the mobile device to share content (e.g., images, video, audio segments, text, etc.) with the media device.

In some instances, the mobile device may be authenticated before transmitting the request to the computing device. For example, the mobile device may transmit an identification of a user account of the media sharing application executing on the mobile device and access credentials that authenticate the identity of a user of the mobile device. In some instances, the mobile device may request a token (e.g., a JWT token, an object, etc.) from an authentication service. The mobile device and/or the user thereof may be authenticated by the authentication service using for example, access credentials, cryptographic keys, digital signature, tokens, personal identifiable information, and/or the like. Once authenticated, the authentication service may transmit a token (e.g., also referred to as a sending token) associate with the mobile device and/or the user thereof. The mobile device may provide the token to the computing device to identify the mobile device as an authenticated device. In some instances, the token may expire to cause the mobile device to repeat the authentication process with the authentication service.

The mobile device may transmit the token with the request to transmit the communication to indicate that the mobile device and/or the request is authenticated. The computing device may then use information in the request to identify the media device. The media device may be a device associated with a same user (e.g., such as a media device operated by a same user as the user operating the mobile device) or the media device may be associated with a different user that is a contact of the user operating the mobile device. The computing device may identify a user account associated with the request using a name of the receiving user, a user identifier corresponding to the receiving user, an identifier of a user account, a device identifier, a device address (e.g., an IP address, a MAC address, etc.), and/or the like. The computing device may perform a user account search to identify a media device associated with the user account.

The computing device may then determine characteristics from device information associated with the computing device. The device information may include an identification of the media device, an address of the device (e.g., an IP address, MAC address, a URL, a memory address, or the like), a device type (such as, but not limited to, a smartphone, tablet, computing device, server, television, monitor, etc.), processing capabilities (e.g., processing cores, processing speed, amount of volatile and/or volatile memory, presence of a graphics processing unit (GPU), an identification of a quantity GPU cores, graphical processing unit memory or video memory, an identification of a maximum resolution of a display, refresh rate of the display, a response time of the display, etc.), an identification of connected peripherals (e.g., such as a camera, microphone, keyboard, etc.), an identification software installed on the device (e.g., such as a media-sharing application, operating system, etc.), user preferences (e.g., presentation preferences, etc.), combinations thereof, or the like.

At block 1008, the computing device may generate an identifier associated with the media and a signed uniform resource locator (URL). The computing device may generate one or more identifiers associated with the communication to enable tracing the communication and authenticating access to the communication. In some instances, the computing device may generate a first identifier that corresponds to the communication and a second identifier that corresponds to the content to be included in the communication. If the content includes two or more media instances, then an identifier may be generated for each instance of media.

The signed URL may be usable by the mobile device to upload the content to be included in the communication. Alternatively, the computing device may transmit an identification of aa network address, memory address, etc. to the mobile device to enable the mobile device to upload the content.

At block 1012, the computing device may receive, via the signed uniform resource locator, the content. The content may be stored in association with the signed uniform resource locator. For instance, the content may be stored in a memory space defined based on the signed uniform resource locator. Alternatively, or additionally, the content may be stored in association with the communication identifier (e.g., the first identifier) and/or the one or more second identifiers associated with the content. For example, the first identifier and/or the one or more second identifiers may be translated into a memory address usable to store the content.

At block 1016, the computing device may transcode the content based on characteristics of the media device. The computing device may include one or more transcoders with each transcoder being configured to transcode different input content and/or generate different output content. For example, a first transcoder may be configured to transcode an image file into video by wrapping the image into a video-based container and setting a flag in the image file header to cause the image file to be recognized as an I-Frame. The image file may be presented as an adaptive bitrate stream comprising a single frame of video. The first transcoder or a second transcoder may be configured to modify the single frame of video to enable the presentation of the single frame of video to take advantage of the processing capabilities of the media device. For instance, the first transcoder or the transcoder may increase a resolution of the single frame of video, adjust an aspect ratio, adjust a frame rate (for content comprising more than one frame of video), perform color correction or other image processes (e.g., increase or decrease sharpness, change a depth of field, etc.), etc. The computing device may select the transcoder to transcode the content based on the media device, the content, and/or user preferences.

The computing device may define one or more fields in the transcode image file to further define the presentation of the content. For example, the computing device may define access restrictions that may require the media device to enter in access credentials to present the transcoded content (e.g., a pin, username and password, voice key, cryptographic key, etc.) and/or define a expiration of the content. For example, the computing device may define the expiration so that the content is deleted (or prevented from presentation) after a predetermined time interval. The predetermined time interval may be configured to start when the content is received at the media device or when the content is first presented by the media device. The one or more fields may also define presentation characteristics such as, but not limited to, a presentation size, a presentation layout, a thumbnail of the content, a presentation location of the transcoded content or the thumbnail, etc.)

At block 1020, the computing device may transmit the communication to the media device. In some instances, the communication can be transmitted by transmitting the signed URL to the media device enabling the media device to download the communication using the URL. In other instances, the communication may be transmitted over web-based communication protocol or other network protocol. The communication may include the transcoded content and an identification of the user account associated with the mobile device and/or the user thereof. The transcoded content may be presented by the media device according to the presentation characteristics

The following include example features of the media sharing system. A media sharing system may include more or fewer features than described.

Backend API: The backend API may be responsible for authenticating incoming API requests to the backend services for the media sharing system such as, but not limited to, retrieving the direct signed upload URL, listing videos owned, listing videos that have access to, revoking videos shared with others, etc. The backend API may interact with a database, media services APIs, and identity services APIs.

Authentication Service: Authentication may be performed using signed tokens from a third-party authentication service. The tokens may enable the mobile device and/or the media device to perform authentication.

Tech Stack: The Backend API may be a monolithic code base with different routes and with calls to account and media service helper APIs. In some instances, the Backend API may not be a microservice architecture to prevent fragmentation of the code base.

Database: the database may store an identification of user accounts, an identification of relationships between user accounts, an identification of relationships of account access to media, access a media status, combinations thereof, or the like. A unique user identifier, or if not available a unique device identifier, may be used as a partition key of the database.

Media Services APIs: Media services may supply APIs for deleting videos and for getting direct signed upload URLs.

Identity Services APIs: The API may enable access to list the friends connected to the current account, remove and add friends to the account, and/or the like.

Media Ingest and Conversion, Uploading Media: Signed Direct Upload URLs may enable upload access to a cloud service bucket. The URLs may be valid multiple times up to an expiration date and time. An API endpoint behind the Backend API may provide the signed URL to upload media. A unique identifier may be assigned to the media to be uploaded along with the direct upload URL to the client. Upload states may be stored to enable resumable uploads. Thumbnails may be created. Uploading to the cloud service bucket can trigger processing and conversion by a cloud service media convert process.

The Backend API may manage expiration of content with a lambda function. The media sharing system may use a transaction lock on the status of content in the database to prevent race conditions.

Mobile App: The mobile application may include tabs with a first tab for grams. The mobile application may be used to request contacts, remove contacts, block and/or unblock contacts, share content (e.g., with other mobile devices and/or media devices, etc.), etc. Shared content may be transmitted via a direct upload link to the API. In some instances, the mobile app may convert the images into a Joint Photographic Experts Group (JPEG) or other image format before transmitting the content to the server.

Webpage: A webpage associated with the media sharing system may direct users to download the mobile Application. The webpage may be accessed if a contact request link is accessed outside a mobile device. If the contact request link is accessed from a mobile device, the friend request link may deep link into the mobile application or take the user to an app store to download the mobile application.

Operational Infrastructure: Features of the display device application and the mobile applications can be added and/or removed to optimize resource utilization locally (e.g., at the display device and the mobile device respectively) and remotely (e.g., servers, cloud networks, etc.). In some instances, a ‘getConfiguration’ API backend call may be executed to enable or disable individual features. Logging can also be selectively increased or decreased via remote configuration API call on a per mobile device or display device basis.

In some instances, the backend APIs can be hosted in a cloud-service-based container.

Metrics Collection: Metrics and log collection on the mobile application, display device application, and the Backend APIs can be stored centrally or in distributed databases. The metrics and logs can be searched via a local interface or a web-based interface (e.g., from any location).

FIG. 13 illustrates an example computing device according to aspects of the present disclosure. For example, computing device 1300 can implement any of the systems or methods described herein. In some instances, computing device 1300 may be a component of or included within a media device. The components of computing device 1300 are shown in electrical communication with each other using connection 1306, such as a bus. The example computing device 1300 includes a processor 1304 (e.g., CPU, processor, or the like) and connection 1306 (e.g., such as a bus, or the like) that is configured to couple components of computing device 1300 such as, but not limited to, memory 1320, read only memory (ROM) 1318, random access memory (RAM) 1316, and/or storage device 1308, to processor 1304.

Computing device 1300 can include a cache 1302 of high-speed memory connected directly with, in close proximity to, or integrated within processor 1304. Computing device 1300 can copy data from memory 1320 and/or storage device 1308 to cache 1302 for quicker access by processor 1304. In this way, cache 1302 may provide a performance boost that avoids delays while processor 1304 waits for data. Alternatively, processor 1304 may access data directly from memory 1320, ROM 1317, RAM 1316, and/or storage device 1308. Memory 1320 can include multiple types of homogenous or heterogeneous memory (e.g., such as, but not limited to, magnetic, optical, solid-state, etc.).

Storage device 1308 may include one or more non-transitory computer-readable media such as volatile and/or non-volatile memories. A non-transitory computer-readable medium can store instructions and/or data accessible by computing device 1300. Non-transitory computer-readable media can include, but is not limited to magnetic cassettes, hard-disk drives (HDD), flash memory, solid state memory devices, digital versatile disks, cartridges, compact discs, random access memories (RAM 1325), read only memory (ROM), combinations thereof, or the like.

Storage device 1308, may store one or more services, such as service 1 1310, service 2 1312, and service 3 1314, that are executable by processor 1304 and/or other electronic hardware. The one or more services include instructions executable by processor 1304 to: perform operations such as any of the techniques, steps, processes, blocks, and/or operations described herein; control the operations of a device in communication with computing device 1300; control the operations of processor 1304 and/or any special-purpose processors; combinations therefor; or the like. Processor 1304 may be a system on a chip (SOC) that includes one or more cores or processors, a bus, memories, clock, memory controller, cache, other processor components, and/or the like. A multi-core processor may be symmetric or asymmetric.

Computing device 1300 may include one or more input devices 1322 that may represent any number of input mechanisms, such as a microphone, a touch-sensitive screen for graphical input, keyboard, mouse, motion input, speech, media devices, sensors, combinations thereof, or the like. Computing device 1300 may include one or more output devices 1324 that output data to a user. Such output devices 1324 may include, but are not limited to, a media device, projector, television, speakers, combinations thereof, or the like. In some instances, multimodal computing devices can enable a user to provide multiple types of input to communicate with computing device 1300. Communications interface 1326 may be configured to manage user input and computing device output. Communications interface 1326 may also be configured to managing communications with remote devices (e.g., establishing connection, receiving/transmitting communications, etc.) over one or more communication protocols and/or over one or more communication media (e.g., wired, wireless, etc.).

Computing device 1300 is not limited to the components as shown if FIG. 13. Computing device 1300 may include other components not shown and/or components shown may be omitted

The following examples corresponding to various interchangeable implementations of the present disclosure. Any reference to a series of examples is to be understood as a reference to each of those examples disjunctively (e.g., “Examples 1-4” is to be understood as “Examples 1, 2, 3, or 4”).
Example 1 is a system comprising: one or more processors; and a non-transitory machine-readable storage medium storing instructions that when executed by the one or more processors, cause the one or more processors to perform operations including: receiving a request to transmit a communication to a media device, the request including an identification of media; generating an identifier associated with the media and a signed uniform resource locator; receiving via the signed uniform resource locator, the media, wherein the media is stored in associated with the signed uniform resource locator; transcoding the media based on characteristics of the media device; transmitting the communication to the media device, wherein the communication includes the transcoded media.
Example 2 is the system of any of example(s) 1 and 3-7, wherein the operations further include: determining that a quantity of time associated with the request to transmit the communication exceeds a threshold; and deleting the media, the signed uniform resource locator, and the identifier associated with the media.
Example 3 is the system of any of example(s) 1-2 and 4-7, wherein the media includes one or more of text, audio, an image, or video.
Example 4 is the system of any of example(s) 1-3 and 5-7, wherein the media is transcoded into an adaptive bitrate stream.
Example 5 is the system of any of example(s) 1-4 and 6-7, wherein the media includes an image, and wherein the media is transcoded by encoding the image into a video program stream protocol and setting a flag in a header of the video program stream protocol to identify the image as an I-Frame.
Example 6 is the system of any of example(s) 1-5 and 7, wherein the media is transcoded into a highest resolution presentable by the media device.
Example 7 is the system of any of example(s) 1-6, wherein the operations further include: compressing a portion of the media to generate a reduced-size representation of the media, wherein the reduced-size representation of the media is configured to be presented by the media device as a representation of the media; and storing the reduced-size representation of the media in association with the media.
Example 8 is a method comprising: receiving a request to transmit a communication to a media device, the request including an identification of media; generating an identifier associated with the media and a signed uniform resource locator; receiving via the signed uniform resource locator, the media, wherein the media is stored in associated with the signed uniform resource locator; transcoding the media based on characteristics of the media device; transmitting the communication to the media device, wherein the communication includes the transcoded media.
Example 9 is the method of any of example(s) 8 and 10-14, further comprising: determining that a quantity of time associated with the request to transmit the communication exceeds a threshold; and deleting the media, the signed uniform resource locator, and the identifier associated with the media.
Example 10 is the method of any of example(s) 8-9 and 11-14, wherein the media includes one or more of text, audio, an image, or video.
Example 11 is the method of any of example(s) 8-10 and 12-14, wherein the media is transcoded into an adaptive bitrate stream.
Example 12 is the method of any of example(s) 8-11 and 13-14, wherein the media includes an image, and wherein the media is transcoded by encoding the image into a video program stream protocol and setting a flag in a header of the video program stream protocol to identify the image as an I-Frame.
Example 13 is the method of any of example(s) 8-12 and 14, wherein the media is transcoded into a highest resolution presentable by the media device.
Example 14 is the method of any of example(s) 8-13, further comprising: compressing a portion of the media to generate a reduced-size representation of the media, wherein the reduced-size representation of the media is configured to be presented by the media device as a representation of the media; and storing the reduced-size representation of the media in association with the media.
Example 15 is a non-transitory machine-readable storage medium storing instructions that when executed by the one or more processors, cause the one or more processors to perform operations including: receiving a request to transmit a communication to a media device, the request including an identification of media; generating an identifier associated with the media and a signed uniform resource locator; receiving via the signed uniform resource locator, the media, wherein the media is stored in associated with the signed uniform resource locator; transcoding the media based on characteristics of the media device; transmitting the communication to the media device, wherein the communication includes the transcoded media.
Example 16 is the non-transitory machine-readable storage medium of any of example(s) 15 and 17-20 wherein the operations further include: determining that a quantity of time associated with the request to transmit the communication exceeds a threshold; and deleting the media, the signed uniform resource locator, and the identifier associated with the media.
Example 17 is the non-transitory machine-readable storage medium of any of example(s) 15-16 and 18-20, wherein the media includes one or more of text, audio, an image, or video.
Example 18 is the non-transitory machine-readable storage medium of any of example(s) 15-18 and 19-20, wherein the media is transcoded into an adaptive bitrate stream.
Example 19 is the non-transitory machine-readable storage medium of any of example(s) 15-18 and 20, wherein the media includes an image, and wherein the media is transcoded by encoding the image into a video program stream protocol and setting a flag in a header of the video program stream protocol to identify the image as an I-Frame.
Example 20 is the non-transitory machine-readable storage medium of any of example(s) 15-19, wherein the operations further include: compressing a portion of the media to generate a reduced-size representation of the media, wherein the reduced-size representation of the media is configured to be presented by the media device as a representation of the media; and storing the reduced-size representation of the media in association with the media.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored in a form that excludes carrier waves and/or electronic signals. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Some portions of this description describe examples in terms of algorithms and symbolic representations of operations on information. These operations, while described functionally, computationally, or logically, may be implemented by computer programs or equivalent electrical circuits, microcode, or the like. Furthermore, arrangements of operations may be referred to as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module can be implemented with a computer-readable medium storing computer program code, which can be executed by a processor for performing any or all of the steps, operations, or processes described.

Some examples may relate to an apparatus or system for performing any or all of the steps, operations, or processes described. The apparatus or system may be specially constructed for the required purposes, and/or it may comprise a general-purpose computing device selectively activated or reconfigured by a computer program stored in memory of computing device. The memory may be or include a non-transitory, tangible computer readable storage medium, or any type of media suitable for storing electronic instructions, which may be coupled to a bus. Furthermore, any computing systems referred to in the specification may include a single processor or multiple processors.

While the present subject matter has been described in detail with respect to specific examples, it will be appreciated that those skilled in the art, upon attaining an understanding of the foregoing, may readily produce alterations to, variations of, and equivalents to such embodiments. Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter. Accordingly, the present disclosure has been presented for purposes of example rather than limitation, and does not preclude the inclusion of such modifications, variations, and/or additions to the present subject matter as would be readily apparent to one of ordinary skill in the art.

For clarity of explanation, in some instances the present disclosure may be presented as including individual functional blocks including functional blocks comprising devices, device components, steps or routines in a method embodied in software, or combinations of hardware and software. Additional functional blocks may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual examples may be described herein as a process or method which may be depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not shown. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

Devices implementing the methods and systems described herein can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. The program code may be executed by a processor, which may include one or more processors, such as, but not limited to, one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A processor may be a microprocessor; conventional processor, controller, microcontroller, state machine, or the like. A processor may also be implemented as a combination of computing components (e.g., a combination of a DSP and a microprocessor, a plurality of microprocessors, one or more microprocessors in conjunction with a DSP core, or any other such configuration). Accordingly, the term “processor,” as used herein may refer to any of the foregoing structure, any combination of the foregoing structure, or any other structure or apparatus suitable for implementation of the techniques described herein. Functionality described herein also can be embodied in peripherals or add-in cards. Such functionality can also be implemented on a circuit board among different chips or different processes executing in a single device, by way of further example.

In the foregoing description, aspects of the disclosure are described with reference to specific examples thereof, but those skilled in the art will recognize that the disclosure is not limited thereto. Thus, while illustrative examples of the disclosure have been described in detail herein, it is to be understood that the inventive concepts may be otherwise variously embodied and employed, and that the appended claims are intended to be construed to include such variations. Various features and aspects of the above-described disclosure may be used individually or in any combination. Further, examples can be utilized in any number of environments and applications beyond those described herein without departing from the broader spirit and scope of the disclosure. The disclosure and figures are, accordingly, to be regarded as illustrative rather than restrictive.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or media devices of the computing platform. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claims.

1. A system comprising:
one or more processors; and
a non-transitory machine-readable storage medium storing instructions that when executed by the one or more processors, cause the one or more processors to perform operations including:
receiving a request to transmit a communication to a media device, the request including an identification of media;
generating an identifier associated with the media and a signed uniform resource locator;
receiving via the signed uniform resource locator, the media, wherein the media is stored in associated with the signed uniform resource locator;
transcoding the media based on characteristics of the media device; and
transmitting the communication to the media device, wherein the communication includes the transcoded media.

2. The system of claim 1, wherein the operations further include:
determining that a quantity of time associated with the request to transmit the communication exceeds a threshold; and
deleting the media, the signed uniform resource locator, and the identifier associated with the media.

3. The system of claim 1, wherein the media includes one or more of text, audio, an image, or video.

4. The system of claim 1, wherein the media is transcoded into an adaptive bitrate stream.

5. The system of claim 1, wherein the media includes an image, and wherein the media is transcoded by encoding the image into a video program stream protocol and setting a flag in a header of the video program stream protocol to identify the image as an I-Frame.

6. The system of claim 1, wherein the media is transcoded into a highest resolution presentable by the media device.

7. The system of claim 1, wherein the operations further include:
compressing a portion of the media to generate a reduced-size representation of the media, wherein the reduced-size representation of the media is configured to be presented by the media device as a representation of the media; and
storing the reduced-size representation of the media in association with the media.

8. A method comprising:
receiving a request to transmit a communication to a media device, the request including an identification of media;
generating an identifier associated with the media and a signed uniform resource locator;
receiving via the signed uniform resource locator, the media, wherein the media is stored in associated with the signed uniform resource locator;
transcoding the media based on characteristics of the media device; and
transmitting the communication to the media device, wherein the communication includes the transcoded media.

9. The method of claim 8, further comprising:
determining that a quantity of time associated with the request to transmit the communication exceeds a threshold; and
deleting the media, the signed uniform resource locator, and the identifier associated with the media.

10. The method of claim 8, wherein the media includes one or more of text, audio, an image, or video.

11. The method of claim 8, wherein the media is transcoded into an adaptive bitrate stream.

12. The method of claim 8, wherein the media includes an image, and wherein the media is transcoded by encoding the image into a video program stream protocol and setting a flag in a header of the video program stream protocol to identify the image as an I-Frame.

13. The method of claim 8, wherein the media is transcoded into a highest resolution presentable by the media device.

14. The method of claim 8, further comprising:
compressing a portion of the media to generate a reduced-size representation of the media, wherein the reduced-size representation of the media is configured to be presented by the media device as a representation of the media; and
storing the reduced-size representation of the media in association with the media.

15. A non-transitory machine-readable storage medium storing instructions that when executed by one or more processors, cause the one or more processors to perform operations including:
receiving a request to transmit a communication to a media device, the request including an identification of media;
generating an identifier associated with the media and a signed uniform resource locator;
receiving via the signed uniform resource locator, the media, wherein the media is stored in associated with the signed uniform resource locator;
transcoding the media based on characteristics of the media device; and
transmitting the communication to the media device, wherein the communication includes the transcoded media.

16. The non-transitory machine-readable storage medium of claim 15, wherein the operations further include:
determining that a quantity of time associated with the request to transmit the communication exceeds a threshold; and
deleting the media, the signed uniform resource locator, and the identifier associated with the media.

17. The non-transitory machine-readable storage medium of claim 15, wherein the media includes one or more of text, audio, an image, or video.

18. The non-transitory machine-readable storage medium of claim 15, wherein the media is transcoded into an adaptive bitrate stream.

19. The non-transitory machine-readable storage medium of claim 15, wherein the media includes an image, and wherein the media is transcoded by encoding the image into a video program stream protocol and setting a flag in a header of the video program stream protocol to identify the image as an I-Frame.

20. The non-transitory machine-readable storage medium of claim 15, wherein the operations further include:
compressing a portion of the media to generate a reduced-size representation of the media, wherein the reduced-size representation of the media is configured to be presented by the media device as a representation of the media; and
storing the reduced-size representation of the media in association with the media.
